(19) United States
(12) Patent Application Publication
(10) Pub. No.: US 2008/0085495 A1
(43) Pub. Date: Apr. 10, 2008

(54) KIT FOR DEVELOPING A PATTERNED PAINTED SURFACE AND ROLLER ELEMENTS AND METHOD EMPLOYED THEREWITH

(76) Inventor: Carmen Odom, Paris, TN (US)

Correspondence Address: PITTS AND BRITTIAN P C, P O BOX 51295, KNOXVILLE, TN, 37950-1295, US

(21) Appl. No.: 11/535,633

(22) Filed: Sep. 27, 2006

(51) Int. Cl. G09B 11/10

(52) U.S. Cl. 434/84

(57) ABSTRACT

A kit which comprising a package containing those items necessary to develop a patterned painted scene, and particularly a camouflage pattern, on a surface of an object and including instructions as to how to utilize such items to develop the patterned painted scene. These items may include multiple cans of paint of different colors, at least one patterned paint roller for applying the paint, and trays for holding the paints for loading the rollers with paint. One or more of the items in the kit is designed to instruct the user in the application of a multiplicity of compatible layers of differently colored paints over all or a part of the surface to be camouflaged, employing the patterned rollers. A unique paint roller element and a method for developing a patterned painted scene are disclosed.

### CROSS-REFERENCE TO RELATED APPLICATIONS

Not Applicable

### STATEMENT REGARDING FEDERALLY SPONSORED RESEARCH OR DEVELOPMENT

Not Applicable

### FIELD OF INVENTION

The present invention relates to the development of patterned painted surfaces, such as a camouflaged surface, and particularly to a kit useful for developing a patterned painted surface, such as a camouflage pattern on a boat, all terrain vehicle, truck, hunting blind, outdoor shed, wall, roof or other surface.

### BACKGROUND OF INVENTION

At times it is desired to camouflage a boat, motor vehicle, or other items commonly associated with the hunting sports, bird watching, animal habit studies and like ventures. Camouflage also is commonly employed in military environments. In similar manner, at times, generation of an outdoor scene is desired for an interior wall of a building.

Heretofore, it has been common to use a template to paint a camouflage pattern on at least the outwardly exposed surface or surfaces of an object, such as a boat, etc. to be camouflaged. This activity heretofore involved several steps, each being carried out substantially independently of the other. For example, heretofore, one had to research (a) a pattern of camouflage for a given environment, e.g., a desert environment, a green forest environment, a winter forest environment, an environment which included a body of water (e.g., lake, river or ocean, a blue sky environment, (b) the appropriate paints to be used, i.e., color(s), and the compatibility of the multiple colors of paints, (c) method of application of the camouflage to the object, (d) and possibly the most difficult issue of all, how to develop a pattern for the camouflage. In this latter respect, considerable personal artistic aptitude is most helpful. This talent requirement has resulted in an industry directed to the design and production of templates or stencils. These products, however, limit the choice of landscape, camouflage, etc. to those templates which are commercially available. Among other things, such commercial templates are limited to the size offered commercially and are rather expensive, many being single use templates, and time consuming to use. When using either templates or when “free-hand” painting of a landscape, camouflage or other scene, there remains the necessity of the user to seek out sources of each of those products which their research revealed to be necessary to develop the desired camouflage, all at the expense of time and money.

In the present disclosure, the pattern to be painted onto a surface is referred to as a “camouflage” pattern or “camouflaging” a surface or object. It will be understood that the pattern need not be “camouflage”, but may be any of a large variety of scenes, particularly outdoor scenes.

### BRIEF SUMMARY OF THE INVENTION

In accordance with one aspect of the present invention, there is provided a kit which comprises a package containing those items necessary to develop a patterned painted surface without employing a template, and particularly a camouflage pattern on a surface of an object, and including instructions as to how to utilize such items to develop the patterned painted scene. These items may include multiple cans of compatible paints of different colors, at least one patterned paint roller for applying the paint, and trays for holding the paints for loading the rollers with paint. One or more of the items in the kit is designed to instruct the user in the application of a multiplicity of compatible layers of differently colored paints over all or a part of the surface to be camouflaged, employing the patterned rollers.

### BRIEF DESCRIPTION OF THE FIGURES

FIG. 1 is a representation of a typical kit embodying various of the features of the present invention,

FIG. 2 is an exploded schematic representation of various components of the kit depicted in FIG. 1;

FIG. 3 is a representation of a typical first roller element of the present invention and depicting one pattern of a given paint which may be applied to a paintable surface upon one rotation of the depicted first roller element about its rotational axis;

FIG. 4 is a representation of a first roller element of the present invention and including a representation of one pattern of a given paint which may be applied to a paintable surface upon one rotation of the depicted first roller element when employing only an outboard end portion of the depicted roller;

FIG. 5 is a representation of a second roller element of the present invention, and depicting a representation of one pattern of a given paint which may be applied to a paintable surface upon one rotation of the depicted second roller element;

FIG. 6 is a representation of one pattern of paint which may be applied to a surface upon one rotation of the second roller element as depicted in FIG. 5 when employing only an outboard end portion of the depicted roller;

FIG. 7 is a representation of a portion of the side of the bow end of a boat having a camouflage pattern painted thereon employing a kit of the present invention;

FIG. 8 is a representation of a wall having a camouflage pattern of a tree trunk and associated limbs painted thereon employing a kit of the present invention; and,

FIG. 9 is a schematic representation of a unitary cylinder of a polymeric foam useful in the forming of one embodiment of a roller element of the present invention.

### DETAILED DESCRIPTION OF INVENTION

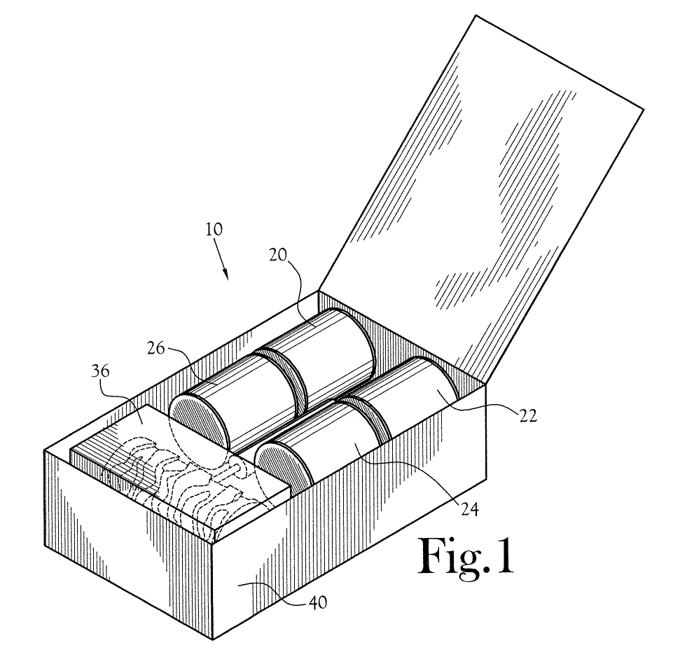

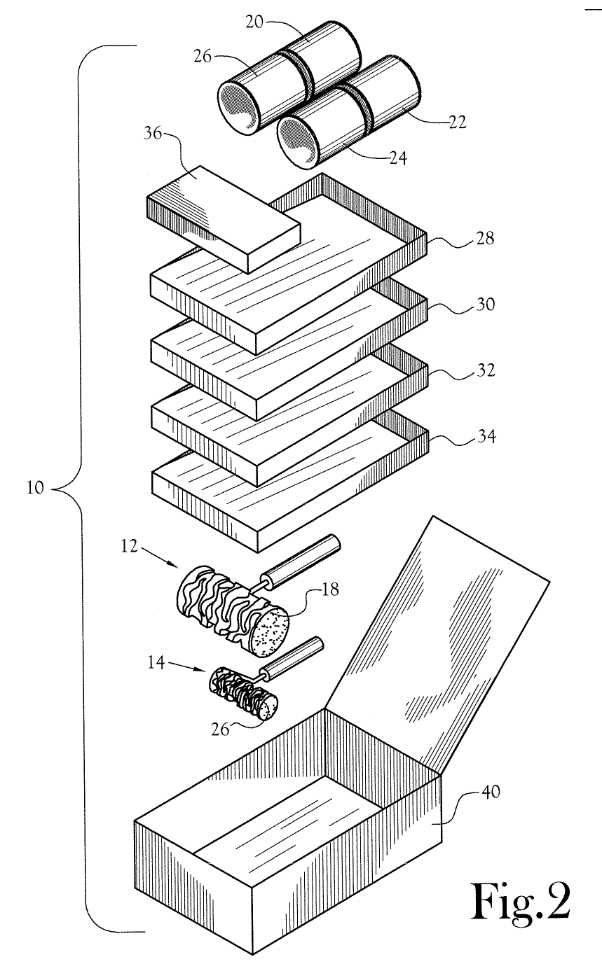

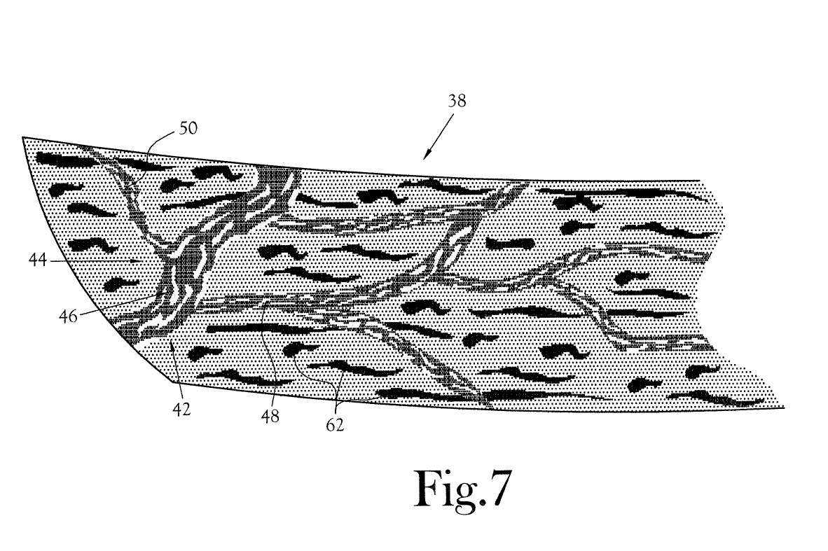

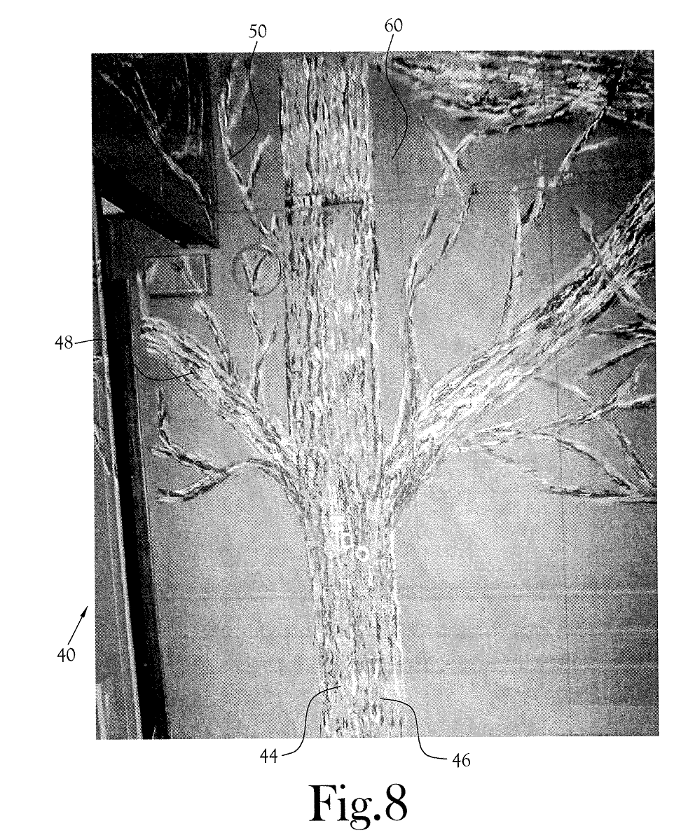

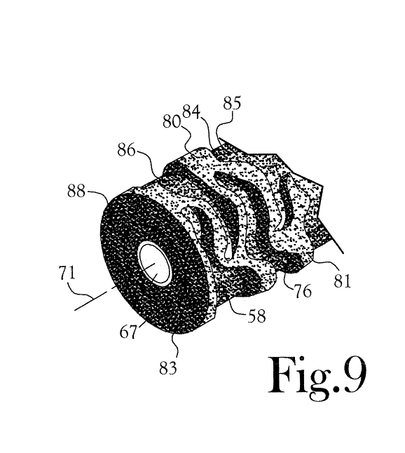

With reference to FIGS. 1 and 2, in one embodiment of a kit of the present invention there is included at least first and second paint rollers 12 and 14, respectively, having their respective outer cylindrical surfaces 16 and 18 defined in accordance with various aspects of the present invention, a quantity of each of a plurality of compatible paints 20,22,24 and 26 of differing colors, a paint tray 28,30,32, and 34 for each of the paint colors, and instructional materials 36 for the use of the kit to develop a painted camouflage pattern on the surface of an object, such as a boat 38 (see FIG. 7), or a wall (see FIG. 8). The instructional materials may include printed materials and/or instructions on an electronic medium, such as a VHS tape, CD, or DVD disc(s). These, and such other items as may be employed in the development of a given patterned painted scene on a surface, are compactly housed within a strong container 40, such as a corrugated cardboard box for handling, storage and/or shipping.

As depicted in FIGS. 7 and 8, the present kit may be employed to paint an outdoors scene depicting a portion of a tree 44, including the tree truck 46 and one or more associated tree limbs 48 and 50, for example, on a boat 38 (see FIG. 7), or an inside wall 60 of a house (see FIG. 8), as desired. Each of the depicted scenes includes principally one or more trees or major portions of a tree, at the option of the user. As depicted in FIGS. 7 and 8, additional features of the tree, such as bark 62, may be depicted. Given the present disclosure, it will be recognized by one skilled in the art that the scene to be painted may be chosen from an almost endless number or variations of scenes.

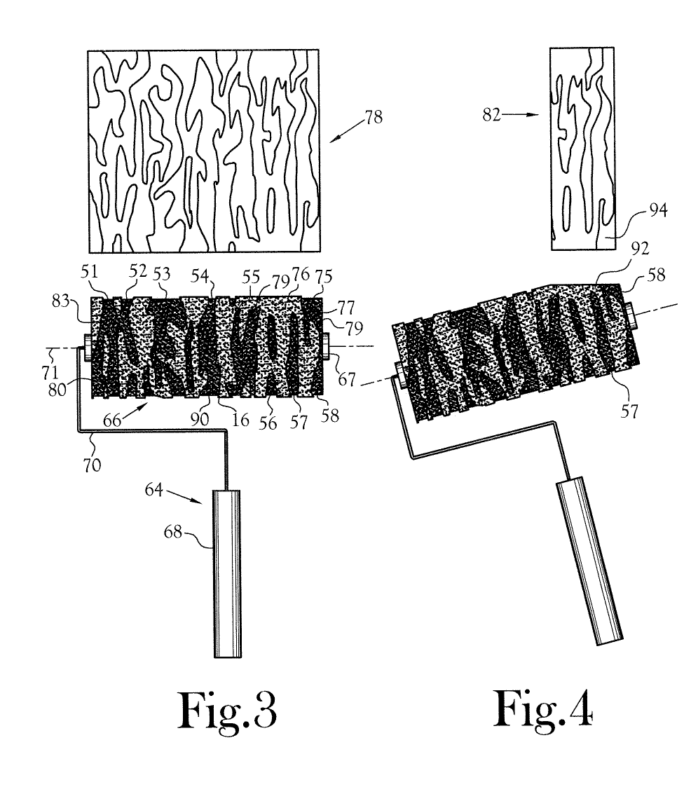

With reference to FIG. 3, a typical first paint roller 12 includes a handle 64 having an elongated, generally cylindrical patterned roller element 66 mounted thereon employing a cylindrical core 67. The depicted handle includes a first portion 68 adapted to be grasped in a user's hand, and a second portion 70 which extends substantially perpendicular to the first portion. This second portion functions to receive and support a first roller element 66 thereon for rotation of the first roller element about its rotational axis 71. Handles of this nature are well known in the painting art.

Each roller element of the paint rollers of the present invention is formed of a material such as a resilient, flexible, porous, polymeric material. Polyurethane foam may be employed in one embodiment of the present roller elements.

The first elongated roller element 66, as depicted in FIGS. 3 and 4, includes an outer circumferential surface 16 which is collectively defined by a plurality of generally annular projections 51,52,53,54,55,56,57 and 58 which are aligned in side-by-side, spaced-apart arrangement on a unitary cylinder 83. These projections are generally of substantially equal diameters. The longitudinal centerline of this unitary cylinder defines the rotational axis 71 of the roller element.

Each projection includes an outer circumferential surface 75 which contributes to the overall delivery of paint from the roller element onto a surface to which a camouflage pattern is to be developed. Specifically, each annular projection is shaped in a manner which permits a preselected portion or portions of the outer circumferential surface 75 of the projection to engage the surface to be painted upon each rotation of the roller element as it is rolled over the surface to be painted.

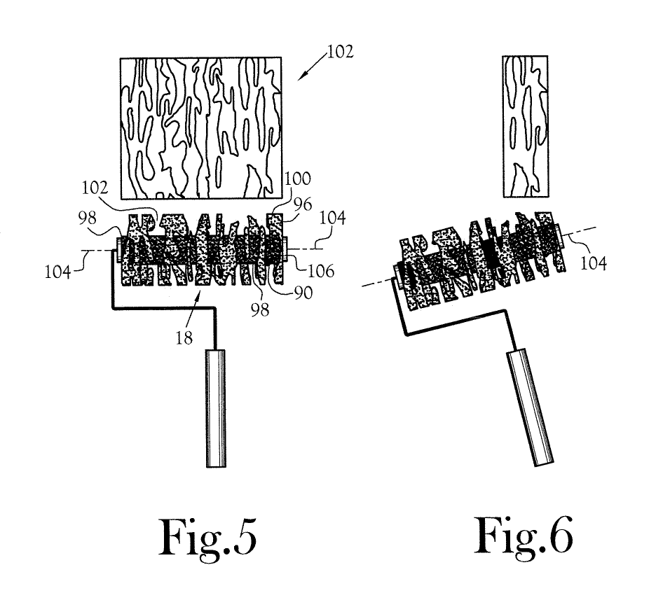

More specifically, referring specifically to FIGS. 9, 3 and 5, in the formation of the roller element, a unitary cylinder 83 of resilient, flexible porous, preferably polymeric, material, is cutaway in a direction from its outer circumferential surface 85 radially inwardly of the unitary cylinder, leaving an open cavity 76 (typical) defined by the side walls of adjacent projections. In a first roller element, such cutaways may terminate radially short of the full radius of the unitary cylinder, some cutaways being radially deeper than others of the cutaways, thereby forming projections which differ in radial height, hence exhibit differing degrees of compression when the roller element is rolled over a surface to be painted. In one embodiment, the cutaways may extend fully through the radius of the cylinder. Further, the side walls 77 and 79 of each projection (projection 58, for example), which result from respective ones of the cutaways may, themselves, be non-parallel with respect to one another. Rather, the contour of each side wall may be chosen to develop differing thickness of the projection along its radial dimension (see dark area of projection 58 of FIG. 3, for example).

Still further, the cutaways which define a given projection may include the removal of polymeric material from the outer circumferential surface of a given projection thereby developing one or more depressions 80 in the outer circumferential surface of such projection(s) so that as the roller element is rolled over a surface, no paint is transferred from the projection to the surface in those areas where there are depressions in the outer circumferential surface of the projection. FIG. 9 depicts schematically multiple cutaways of a typical unitary cylinder of the present invention.

As seen in FIG. 3, each of the cavities 76 includes opposing side walls 75 and 77 which are defined by the outer side walls of adjacent ones of the annular projections. Since the respective wall thicknesses of the annular projections are non-uniform over their respective depth (radial) dimension, the side walls of each cavity are correspondingly contoured, as opposed to straight walls. That is, the cavity most commonly is non-uniform in width over the depth of the cavity.

Additionally, it will be recognized that the cavities defined between the side walls of adjacent projections open outwardly 81 of the circumferential surface of the roller element. Such cavity openings also leave unpainted areas in the pattern produced by each revolution of the roller element over the surface being painted. Accordingly, the choice of the overall geometry of the outer circumferential surface of the roller element may be selected through the choice of the geometry of the cutaways, hence the geometry of the projections. This feature permits the provision of a roller element which, when rolled over the surface being painted by one revolution of the roller element, will develop a desired pattern 78 of paint deposition on the surface.

With reference to FIG. 4, the depicted first roller element may be employed to develop, during a single revolution of the roller element, a pattern 82 which is more narrow than the full pattern 78 depicted in FIG. 3. This feature of the roller element is achieved by contacting the surface being painted with selected ones of the end projections of the roller element. In FIG. 4, only the end projections 57 and 58 are employed in developing the pattern 82 depicted in FIG. 4, during a single revolution of the roller element. Employing more of less projections in engagement with the surface being painted can permit the user to select differing widths of the pattern as depicted in FIG. 4.

Moreover, when employing one or more of the end projections of the roller element, and through selection of the degree of pressure applied to the roller element as it moves through one revolution over the surface being painted, the user may distort the end projections to the extent that the most radially outward portions of their respective side walls engage the surface being painted and thereby contribute to the deposition of paint to the surface. This feature permits the user to widen, or otherwise alter, the painted pattern, as desired.

Thus, it is noted that the overall outer circumferential surface of the roller element, as defined by the outer circumferential surfaces (or cavity openings in such surfaces) is discontinuous over the length dimension of the elongated roller element. Through selection of the location of and/or the geometry of, such discontinuities in the overall outer circumferential surface of the roller element, a basic pattern of paint deposition by the roller element during a single revolution of the roller element along a surface to be painted, may be developed. Multiple variations of this basic pattern may be achieved merely by the user's choice of pressure applied to the roller element during each revolution thereof, and/or by the user's choice of employing less than all of the projections during a single revolution of the roller element over the surface. These features of the plurality of projections and intermediate cavities between adjacent projections result in the deposition of paint from the roller element onto the surface being painted in a pattern which is a function of the respective geometries of the outer circumferential surfaces of the projections and/or the outwardly opening ends of those cavities which are intermediate the projections.

In accordance with one feature of the present invention, the most radially inward portions 86 (typical) of the projections (i.e., most adjacent the rotational axis of the roller element), are not cut away, leaving a substantial volume of the porous material of the unitary cylinder available as an overall generally cylindrical reservoir of liquid paint adjacent the rotational axis of the roller element. By this means, the roller element may be initially loaded with sufficient paint, including the enhanced volume provided adjacent the rotational axis of the roller element, to permit abnormally long single swipes of the roller over a surface to be painted to develop repeating patterns of paint without interruption of the continuity of the overall effect. For example a tree trunk of several feet length may be generated by a single swipe of the roller without a break in the repeating pattern.

As noted, each projection, most commonly, includes a respective wall thicknesses which is non-uniform over the radial dimension of the projection. Moreover, the side walls of each of the plurality of annular projections are non-parallel to one another, and generally may be non-perpendicular to the rotational axis of the roller element. Further, the deviation of one or both of the side walls of a given projection may vary with respect to its degree of non-perpendicularity with respect to the rotational axis of the roller element. According, each projection, most commonly, exhibits a multi-directional irregular annular geometry over its radial dimension, hence an irregular outer annular distal surface between adjacent cavities. This construction of the projections results in a plurality of distally projecting surfaces of varying disparate areas and geometries being in simultaneous contact with a surface to be painted as the roller element, loaded with paint, is rolled over the surface to be camouflaged.

Also as noted, each projection includes at least one side wall. Each such sidewall may be contoured as noted hereinabove. Since the roller element is formed of a flexible resilient material, the projections may be contorted by applying more or less pressure to the roller element as it is passed along the surface to be camouflaged. By this means, more or less of the sidewalls of the projections may be caused to engage the surface being painted to further contribute to that portion of each projection wall which will engage, or not engage, the surface to be camouflaged. Thusly, each cavity and projection may contribute selectively to the versatility of the camouflage pattern developed by the roller element as it is passed over the surface to be camouflaged. These annular distal surfaces of the projections manifest themselves in the form of a pattern 78 of paint, 20 for example, deposited on the surface being camouflaged. (See pattern 78 of FIG. 3, for example.)

Such pressure may be applied generally evenly over the full length of the roller element, or may be applied selectively to those annular projections which are located proximate one of the opposite ends of the roller element. When relatively even pressure is applied to the roller element, one revolution of the roller element of FIG. 3 produces a painted pattern 78 as depicted in FIG. 3. At the choice of the user, application of pressure to those projections proximate an end of the roller element will produce a large variety of painted patterns, depending upon the degree of pressure applied and the angle of contact between the rotational axis 71 of the roller element and the plane of the surface being painted. For example, if the applied pressure is sufficient to distort one or more of those projections proximate an end 92 of the roller element, the painted pattern may reflect painted areas 94 which are generated by the contact of one or more of the inner side walls of the projections, along with the distorted distal surface of these projections, with the surface being painted. It will be recognized that more or less pressure applied to these end projections will produce correspondingly more or less distortion of these annular projections, hence more or less deposition of paint from the inside walls of the projections onto the surface being painted. This effect is available to the user for selection of the density of paint being deposited on the surface and/or the width of a line of paint being deposited on the surface. Other effects of similar nature are obtainable by the user merely using their imagination. Moreover, this feature of the roller elements of the present invention permits the user to utilize a single one of the rollers to generate a relatively wide swath of the full pattern of the roller element or to use the same roller to generate only a narrow line of paint, or by varying the applied pressure as the roller element is rolled along a surface, the width (and intensity) of the painted “line” may vary in width, thereby providing the user with yet another means for applying paint selectively, in area and quantity, in the course of developing a desired patterned painted scene.

FIG. 4 depicts a second roller element 14 included in the kit of the present invention. This second roller element is likewise formed of a material such as a resilient, flexible, porous polymeric material, but is smaller in both length and outer diameter than the first roller element. Also in like manner as the first roller element, this second roller element is defined by a plurality of side-by-side, spaced apart, in register, annular projections 84 (typical) which extend radially from the rotational axis 104 of a unitary cylinder in the manner as depicted in FIG. 9. The unitary cylinder is mounted on a central cylindrical core 67 which is adapted to be fitted onto the handle for the roller element. The annular projections are of substantially equal radial dimensions so that their collective distal outer surfaces 90 define the outer cylindrical surface 18 of the second roller element. Like the first roller element, these annular projections of the second roller element are spaced apart laterally from one another to define a cavity 102 between adjacent ones of the projections. Being resilient and flexible, the projections may be compressed and/or distorted by the user applying more or less pressure when applying paint to a surface employing a roller element of the present invention. Accordingly, the second roller element may be employed in like manner as the first roller element to apply a full pattern of paint (see FIG. 6) or a partial pattern at the will of the user.

The second roller element or the present invention further differs from the first roller element in that in the second roller element, each cavity extends substantially fully to the core 106 on which the unitary cylinder 98 is mounted. This feature provides for increased flexibility of the individual projections for altering the deposition of paint from the roller element onto a surface through the user selecting the degree of pressure applied to the second roller element when rolling such roller element over a surface being painted. In addition to being about one-third of the length of a first roller element, the thickness of the projections of the second roller element are generally less than the thickness of the projections of the first roller element, thereby permitting the application of thinner, more linear lines of paint to be deposited on the surface being painted using the second roller element.

The kit of the present invention includes a plurality of containers of paint 20, 22, 24 and 26, the paint of each container being of a preselected color. Importantly, all the paints are compatible with one another when applied to a surface, thereby permitting either full or partial over-painting of one paint with a further one of the paints. Multiple layers of paints of differing colors are commonly employed to achieve a selected pattern wherein dimensional effects are desired, much as an artist employs in painting a landscape or the like.

In one example of the use of the present kit for generating a camouflage pattern on a boat or the like, those surfaces of the boat to be camouflaged are initially painted with a solid background paint, such as a relatively dark green colored paint. Thereafter, employing a first roller element and brown paint, the outline of at least the truck and multiple limbs of a tree may be painted onto the side of the boat. As desired, multiple trees or parts thereof may be outlined on the boat.

Thereafter, in this example, employing the first roller and a relatively light green paint, a patterned coat of the light green paint is applied over, but only partially covering, the green/brown layers which define the outline of the tree and its limbs.

This third layer of paint is followed by the application of striations of white paint applied to the tree trunk and its limbs in substantially long sweeping strokes, employing the second roller element. Where the width of the limb is less that the width of the second roller element, the second roller element is tilted to cause only selected ones of its end annular projections to engage the surface and thereby paint a thinner pattern of white paint along the limb as is depicted in FIG. 7.

Toning down of the white streaks is next accomplished using either or both of the first and second roller elements and a brown paint, by applying a fourth layer of paint, patterned by reason of the patterns defined by the roller elements, is overpainted onto major portions of the tree trunk and its limbs, thereby completing the camouflaging of the boat.

The foregoing painting sequence, modified with other colors of paint if desired, may be employed to develop an outdoor scene, for example, on any other paintable surface, such as the outer surfaces of an outdoor shed, or the surface of an interior wall of a building, such as in a trophy room, or the like.

It will be appreciated by one skilled in the art that the pattern developed when applying multiple layers of different colored paints to a surface using the patterned rolls of the present invention may be varied. This variability may merely include the choice of the scene and selection of the paints to be employed, the length of individual strokes of a given roller element, etc. Thus, the present kit may be customized to include those components needed to develop a selected patterned painted scene without the use of a template.

Notably, each of the roller elements of the present kit, having extensive exposed surface areas and enhanced reservoir volume, may be loaded initially with an abnormally large quantity of paint. By this means, the roller element may be employed to apply a given layer of paint over all or substantially all of the scene without refilling the pores of the roller element with additional paint. This factor conserves time, but importantly, it also provides a means by which the user may deposit more or less paint over a given area by merely applying more or less pressure to the roller element as it is rolled over the given area by the user.

For expediency, the present kit may include one paint dispensing tray 28, 30, 32 and 34 for each color of paint employed.

In the present kit, in a preferred embodiment, there are provided visual instructions for the development of a given patterned painted scene. Thus, no particular artistic ability is required of the user aside from their personal preferences for variations in the scene. Application of a given layer of paint may be completed in an unexpectedly short time by reason of the capacity of the roller elements, the painting of a major portion of the scene being accomplished by merely by a single stroke of the roller element over the area to be covered, the patterned projections of the roller element filling in only those portions of the scene which are to appear of a selected color in the final version of the scene. That is, a tree trunk, for example, may be outlined in a single passing of the first roller over that area where the tree truck is to appear in the final version. Similarly, overlaying of the different colors onto one another is accomplishing employing single swipes of a selected one of the roller elements over the previously painted outline, leaving a newly colored portion of the pattern deposited on the scene. In this manner, the pattern is developed by the roller elements and the user is not required to individually paint in each and every detail of the scene. This function is provided by the roller elements and the overpainting of the different colors of paint.

Whereas the present invention has been described in terms of specific components of the kit, development of specific scenes employing specified colors of paint, it will be understood by one skilled in the art that various equivalents of the described components, etc., may be employed. For example, different patterns of paint, hence different scenes, deposited on a surface may be achieved employing the first and second roller elements, and/or other equivalent roller elements disclosed herein.

What is claimed:

1. A kit for painting a patterned scene on an object comprising
a) a dispensing container for liquid paint, said container being adapted to accept therein a roller element for the loading of paint onto said roller element;
b) a plurality of individually contained liquid paints useful in developing a preselected patterned painted scene, individual ones of said plurality of liquid paints being of a respective color, said paints being mutually compatible with one another when applied in overlying layers thereof;
c) at least a first paint roller of a first size, said first paint roller including a first elongated roller element having a rotational axis, said roller element being formed of a resilient, flexible, porous polymeric material adapted to receive and dispense respective quantities of a liquid paint, and a plurality of registered annular projections disposed in spaced apart, side-by-side relationship with one another, each of said plurality of projections extending generally radially outwardly from said rotational axis of said first roller element and terminating in the form of respective disparate outer circumferential surface, said disparate outer circumferential surfaces of said projections collectively defining a corresponding disparate outer circumferential surface of said first roller element;
d) packaging adapted, and of a suitable construction material, to retain said container, rollers and paints collected in a single unit during storage, shipment and display at a point of sale of the kit.

2. The kit of claim 1 wherein said outer circumferential surface of said first roller element is discontinuous over its length.

3. The kit of claim 1 wherein said first roller element is reusable.

4. The kit of claim 1 wherein each of said projections includes opposite side walls which are contoured whereby each of said projections is non-uniform in thickness over the radial dimension of the projection, thereby providing an irregular outer circumferential surface for each of said projections.

5. The kit of claim 4 wherein each of said side walls of said plurality of annular projections is porous.

6. The kit of claim 4 wherein the sidewalls of each said projections are non-parallel with respect to one another and the non-parallism of said sidewalls changes around the annular projection thereby providing a multi-directionally irregular annular geometry of said outer circumferential circumference of each of said annular projections.

7. The kit of claim 1 and including a second paint roller element of a second and lesser size than said first roller element and having a rotational axis, said second roller element being formed of a resilient, flexible, porous polymeric material adapted to receive and dispense respective quantities of a liquid paint, and a plurality of registering projections disposed in side-by-side relationship with one another, extending generally radially outwardly from said rotational axis of said second roller element and terminating in the form of an outer circumferential surface, said outer circumferential surfaces of said projections collectively defining an outer circumferential surface of said second roller element.

8. The kit of claim 1 wherein said outer cylindrical surfaces of said annular projections of said first roller element collectively define at least a portion of a selected camouflage pattern which is repeatable with each full revolution of said roller.

9. The kit of claim 8 wherein said cylindrical surfaces of said annular projections of said second roller element collectively define at least a portion of a selected camouflage pattern which is distinct from said camouflage pattern developable employing said first roller element.

10. The kit of claim 1 wherein said roller element includes a radially central porous region defining a reservoir for paint loaded onto said roller element.

11. A paint roller element adapted to apply a patterned painted scene onto a surface comprising an elongated roller element having a rotational axis, said roller element being formed of a resilient, flexible, porous polymeric material adapted to receive and dispense disparate quantities of a liquid paint onto a surface over which said roller element is rolled, and a plurality of annular registering projections disposed in side-by-side relationship with one another, extending generally radially outwardly from said rotational axis of said first roller element and terminating in the form of respective disparate outer circumferential surfaces, said outer circumferential surfaces of said projections collectively defining a disparate outer circumferential surface of said roller element.

12. The paint roller element of claim 11 wherein each of said projections includes opposite side walls which are contoured whereby each of said projections is non-uniform in thickness over the radial dimension of the projections, said opposite side walls being non-parallel with respect to one another, thereby providing an disparate outer circumferential surface for each of said projections.

13. The paint roller of claim 12 wherein each of said side walls of said plurality of annular projections is porous.

14. A method for the development of a patterned painted scene on a surface in the absence of a template comprising the steps of
a) providing a first paint roller element having a rotational axis, said roller element being formed of a resilient, flexible, porous polymeric material adapted to receive and dispense respective quantities of a liquid paint, and a plurality of registering annular projections disposed in side-by-side relationship with one another, extending generally radially outwardly from said rotational axis of said roller element and terminating in the form of an outer circumferential surface, said outer circumferential surfaces of said projections collectively defining an outer patterned circumferential surface of said first roller element;
b) depositing discrete quantities of a paint of a first color within said polymeric material of said elongated roller element;
c) engaging said surface with said roller element and moving the same a single time over a selected path along said surface whereby paint from said polymeric material is deposited onto said surface in a pattern consistent with said patterned cylindrical surface of said roller element;
d) thereafter, depositing discrete quantities of a paint of a second color within said polymeric material of said elongated roller element;
e) thereafter, engaging said surface with said roller element bearing said paint of a second color and moving the same a single time over said selected path of application of said paint of said first color along said surface whereby paint of said second color, is deposited from said polymeric material onto said surface in a pattern consistent with said patterned cylindrical surface of said roller element;
f) thereafter, depositing discrete quantities of a paint of a third color within said polymeric material of said elongated roller element;
g) thereafter, engaging said surface with said roller element and moving the same at least a single time over said selected path of application of said paints of said first and second colors along said surface whereby paint of said third color, is deposited from said polymeric material onto said first and second paints disposed on said surface, said deposition being in a pattern consistent with said patterned cylindrical surface of said roller element.

15. The method of claim 14 including the steps of
a) providing a further paint roller including a further elongated roller element having a rotational axis, said further roller element being formed of a resilient, flexible, porous polymeric material adapted to receive and dispense respective quantities of a liquid paint, and a plurality of registering projections disposed in side-by-side relationship with one another, extending generally radially outwardly from said rotational axis of said further roller element and terminating in the form of an outer circumferential surface, said outer circumferential surfaces of said projections collectively defining an outer patterned circumferential surface of said second roller element, said outer patterned circumferential surface having a pattern distinct from said outer patterned circumferential surface of said first roller element;
b) depositing discrete quantities of a paint of a fourth color within said polymeric material of said elongated further roller element;
c) engaging said surface with said further roller element and moving the same at least a single time over a selected path along said surface whereby paint from said polymeric material is deposited onto said surface in at least partial overlying relationship to said first and second paints in a pattern consistent with said patterned cylindrical surface of said further roller element.
